(19) United States
(12) Patent Application Publication
(10) Pub. No.: US 2014/0136268 A1
(43) Pub. Date: May 15, 2014

(54) Validating Feasibility of Proposed Contract Provisions

(71) Applicant: HEWLETT-PACKARD DEVELOPMENT COMPANY, L.P., Houston, TX (US)

(72) Inventors: Jun Zeng, Sunnyvale, CA (US); Qing Duan, Durham, NC (US); Krishnendu Chakrabarty, Durham, NC (US); I-Jong Lin, Half Moon Bay, CA (US); Gary J. Dispoto, Mountain View, CA (US)

(73) Assignee: HEWLETT-PACKARD DEVELOPMENT COMPANY, L.P., Houston, TX (US)

(21) Appl. No.: 13/678,195

(22) Filed: Nov. 15, 2012

(51) Int. Cl. G06Q 10/06

(52) U.S. Cl. CPC G06Q 10/06312
USPC 705/7.22

(57) ABSTRACT

Validating feasibility of proposed contract provisions includes obtaining a job request with a proposed contract provision at a validation engine, obtaining at the validation engine status information from a production monitoring engine that monitors production resources for completing the job request, and determining with the validation engine whether the proposed contract provision is feasible for executing the job request with the production resources.

### BACKGROUND

Print service providers provide printing resources for companies and individuals to print books, advertising material, posters, photos, and other printed materials. Generally, a customer works with a customer service representative who negotiates the details of the job requests. Customer service representatives generally receive job requests, determine pricing, make due date commitments, and negotiate other contract provisions. Successful negotiation leads to entering into a contract between the customer and the print service provider. Upon successful completion of the print job, the printed material is sent to the shipping addresses provided by the customer or made available for the customer to pick up.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a validation system according to principles described herein.

FIG. 2 is a diagram of an example of a validation system according to principles described herein.

FIG. 3 is a diagram of an example of a customer interface according to principles described herein.

FIG. 4 is a diagram of an example of a method for validating due dates according to principles described herein.

FIG. 5 is a diagram of an example of a validation system according to principles described herein.

FIG. 6 is a diagram of an example of a flowchart of a process for validating due dates according to principles described herein.

### DETAILED DESCRIPTION

The print service provider may receive multiple job requests within a short period of time that have completion dates within a small window. Failure on the print service provider's part to complete the print job on time may result in out of pocket costs that the print service provider pays. For example, the print service provider may send the printed material through a costly express delivery mail service to get the late order to the customer as soon as possible or offer the customer a discount to compensate for the missed deadline. Further, the print service provider may lose future business with the same customer when deadlines are missed.

The principles described herein include a method for validating feasibility of proposed contract provisions, such as due dates or pricing, to be used by print service providers. Such a method includes obtaining a job request with a proposed contract provision at a validation engine, obtaining at the validation engine status information from a production monitoring engine that monitors production resources for completing the job request, and determining with the validation engine whether the proposed contract provision is feasible for executing the job request with the production resources. Such an automated reasoning method prevents a service provider from over committing on jobs. The production resources may include printing services, manufacturing services, research services, repair services, design services, filming services, engineering services, prototyping services, other services, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

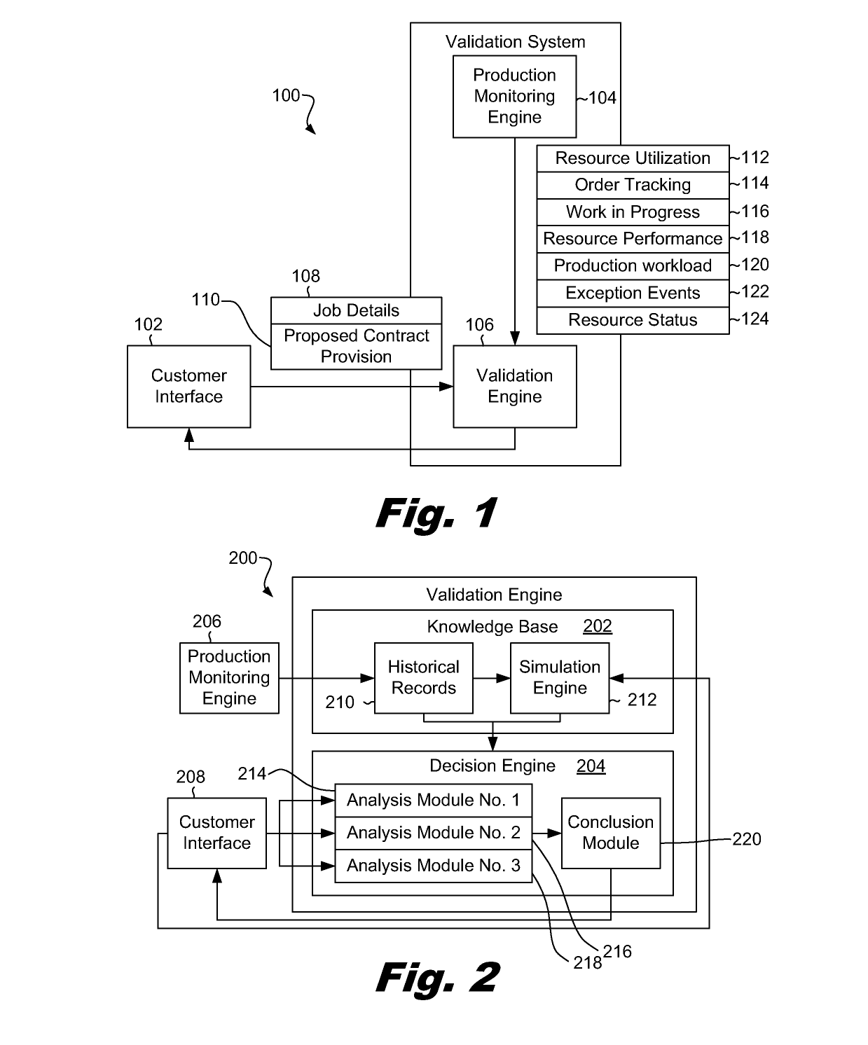

FIG. 1 is a diagram of an example of a validation system (100) according to principles described herein. In this example, various components are identified as engines (104, 106), which are a combination of hardware and program instructions that perform a designated function. Each of the engines includes a processor and a memory, while the program instructions are stored in the memory and executable by the processor to perform the designated function.

In this example, a customer interface (102) and a production monitoring engine (104) are in communication with a validation engine (106). The customer interface (102) may be a computer interface, a tablet interface, a web interface, another type of electronic interface, or combinations thereof. The customer interface (102) may be accessible at the service providers location of business and/or be accessible at a remote location, such as over the internet. A customer makes a job request through the customer interface (102). In some examples, a customer directly interfaces with the print service provider through the customer interface (102) or a customer service representative interfaces through the customer interface (102) on behalf of the customer.

The customer interface (102) has mechanisms to solicit details about the job. For example, the customer interface (102) may have a field where the customer inputs the number of copies that the customer desires, the dimensions of the printed material, the colors of the printed material, a priority status of the job request, a proposed contract provision for the print job, the type of print substrate, an indication of whether the printed material is to be laminated, other information about pre-press factors, other information about press factors, other information about post-press factors, other information, or combinations thereof. The job details (108), including the proposed contract provision (110), are sent to the validation engine (106) where the validation engine (106) determines whether the proposed contract provision is feasible. The validation engine (106) may communicate with the customer interface (102) to provide feedback or re-negotiate a proposed contract provision. Furthermore, the validation engine may provide resource allocation and provisioning guidance to the production system.

Feasibility is the risk that a contract provision will be violated by the service provider. If the risk exceeds an acceptable level by the service provider, then the contract provision is infeasible. The acceptable level is set in the validation engine. Thus, the validation engine is a risk management tool for the service provider. The validation engine seeks out risky contracts for either re-negotiations or requests for new submissions.

The validation engine (106) considers real time information about the printing resources that are provided through the production monitoring engine (104). The production monitoring engine (104) is in communication with sensors or other monitoring tools that measure status information about the production resources. For example, the monitoring tools measure which production resources are currently in use, which production resources are taken off-line requiring services, which job requests are currently in progress, how much longer each job request is likely to take to finish, which parts need to be re-made because of defect, the performance of the printing presses and auxiliary equipment, other information, or combinations thereof. The production monitoring engine (104) sends the resource utilization (112), the order tracking (114), the work in progress information (116), resource performance (118), the production workload (120), the exception events (122), the resource status (124) and other information to the validation engine (106). An exception event may refer to circumstances where an issue arises, such as when a machine overheats, a process fails, the service's products don't pass inspection, other issues, or combinations thereof. Resource status refers to the condition of the resources (i.e. equipment is busy, equipment is idle, equipment is broken, equipment is degraded, equipment is off-line, workers are on vacation, workers are off shift, workers are on breaks, other resources, or combinations thereof).

The simulation engine (212) in the validation engine (106) simulates the conditions of the production resources to determine when the production resources can feasibly execute the job request made through the customer interface (208). The simulated data produced by the simulation engine (212) joins with the historical records (210) from the production monitoring engine (206) to provide the input bases for the validation engine (106) to determine that the proposed contract provision is feasible. The historical records may be processed before joining the simulated data. The historical records may be processed to remove duplicate data. For example, at the time that a proposed contact is accepted, the details about the proposed contract may be recorded. However, out-of-date details for earlier version of the same proposed contract may also be contained in the historical records. Since this information is not needed to determine feasibility, the historical records can be processed to remove the data. Also, the historical records may be further processed to adjust time dependant data. The value of data decays with time, so the historical records should be updated to reflect the most up-to-date information. Samples of the historical records may be taken from different divisions of the historical records. Each division may be based on the records' age. Thus, more samples from the recent divisions are used, while fewer samples from older divisions are used to determine feasibility.

If the proposed contract provision is determined to be feasible, then the validation system (100) accepts the job request and enters into a contract with the customer. On the other hand, if the validation engine (106) determines that the proposed contract provision is not feasible, then the validation system (100) may make recommendations to the customer to find an agreeable alternative. Such alternatives may include postponing the due date or having the customer pay for a higher priority to get the job request done before other jobs that are already in the queue.

Factors to consider when determining the feasibility of the proposed contract provision may include a duration time between making the job request and the proposed due date, the difficulty of the job, the distance that the product of the job is to be shipped, the size of the shipment, the current and forecasted workload of the factory due of existing commitments and other commitments expected to be made that may compete the factory resources with this job, the volume of copies produced, potential bottlenecks in the production process, the potential for repeat business, other factors, and combinations thereof. The validation engine may consider each of the various factors for the requested job, the jobs already in queue, and future jobs with higher priority to jump ahead in the queue that can affect the production resource's ability to execute the requested job when determining the proposed contract provision's feasibility.

The production resources may include all of the equipment needed to fulfill the entire job request or include just a subset of the equipment. For example, if the job request is a printing job, the production resources may include all pre-press equipment, the press, and the post-press equipment. However, in other examples, the press may have the greatest probability of being the bottleneck in the job request, and the validation system considers just the input factors concerning the press. In such an example, the pre-press and post-press equipment may be underutilized compared to the press to such a degree that calculating their status information is unnecessary. Predictive modeling analysis may be simplified by reducing the number of production resources included when determining the proposed contract provision's feasibility.

FIG. 2 is a diagram of an example of a validation system (200) according to principles described herein. The validation system (200) has a knowledge base (202) and a decision engine (204) that interface with the production monitoring engine (206) and the customer interface (208).

The production monitoring engine (206) sends the status information about the production resources to historical records (210) in the knowledge base (202). The knowledge base (202) may request the status information on a real-time, periodic, or on-demand basis. Each datum of the status information is accompanied with a time stamp.

The historical records (210) update its historical libraries to include real time information about the production resources sent from the production monitoring engine (206). As part of the updating process, out-of-date historical records are also removed. The real time status information and the historical records are in communication with a simulation engine (212) that runs a simulation of how the production resources are likely to accomplish 1) the current workload already in the queue, 2) this proposed service contract, and 3) other potential service contracts that are likely to be admitted while the factory is fulfilling this proposed service contract. This simulation accounts for the number of jobs being processed, the number of backlog jobs in queue, the priority of each job, the size of each job, the amount of resources needed for each job, the performance efficiencies of the production resources, other factors, and combinations thereof. This simulation is based on the historical records, so the simulation includes indefinable factors that influence the production resources' performance and not just theoretical conditions. Thus, the simulation is a highly accurate forecast of up-to-the-moment information about the production resources' situation.

By running simulations based on historical records, the simulations based on the same status information may change to become more accurate over time. Data from the historical records or other inputs that do not contribute to accurate predictions are removed. In this manner, the data being used for prediction is also dynamic. The value of historical data decays over time. Thus, the removal of old historical records that are older than a predetermined threshold is used to improve the validation engine's accuracy. While some filtering of old data will occur, the validation engine can incorporate more sophisticated methods for removing inaccurate data than just merely removing old historical records. Such filtering mechanism may include filtering mechanisms that are more relevant to service providers, printers, domain science, or relevant characteristics, or combinations thereof. Thus, the validation engine can include self learning mechanisms that improve its predictions over time.

The results of the simulation are sent to the decision engine (204) where data from the simulation populates variables in different analysis modules (214, 216, 218). Further, the prediction policy may also be updated based on the learned results of the simulation. Historical records such as factory resource utilization and attributes of service contracts fulfilled by the service provider and service levels of these service contracts are also fed to analysis modules (214, 216, 218). Each analysis module (214, 216, 218) is programmed to classify a potential contract into a “on time” classification or a “late” classification. Each of the analysis modules (214, 216, 218) makes their predictions independently of the other analysis modules, and each analysis module (214, 216, 218) approaches its feasibility prediction based on different levels and domains of expertise using the same input data. For example, the different approaches may include neural network mechanisms, logistic regression mechanisms, decision trees mechanisms, Bayesian mechanisms, probabilistic models mechanisms, support vector machines mechanisms, other mechanism, or combinations thereof. The analysis modules include program instructions to create a domain specific classification relating to a feasibility of said contract provision. For example, an “on time” classification and a “late” classification may be used to predict the feasibility of a due date contract provision.

In some examples, the decision engine determines feasibility on all proposed contracts. In other examples, the decision engine determines feasibility on selected proposed contracts. For example, the decision engine may classify the proposed contracts into different groups based on the details of proposed contract. Some of the groups may include contract provisions that are frequently handled with the decision engine, and therefore, the decision engine has a basis for determining feasibility. Most of the proposed contracts may be included in these types of groups and be processed with the decision engine. On the other hand, those groups that have outlier provisions for which the decision engine has little ability to consider may not be processed through the decision engine. Managers may process the proposed contracts within these groups manually.

The training process of each of the analysis modules may need a long duration of time, for example, several or more minutes for this off-line training. However, once the off-line training is complete, the analysis modules may operate in real time. The feasibility prediction criteria of each analysis module are also dynamically adjusted to obtain the highest prediction accuracy for the up-to-the-moment factory status.

The first analysis module (214) may include a nonlinear two-class Support Vector Machine (SVM) using a Sequential Minimal Optimization (SMO) function to train the SVM. To quantify the risk of incurring a penalty with this analysis module, the analysis module considers the risk of obtaining a false prediction. For example, where the analysis modules flags a proposed contract to be “late,” but the contract would actually be completed on time (a false positive), there is no or little cost or penalty associated this false prediction. On the other hand, if the analysis module flags a proposed contract as being “on time,” but the proposed contract should actually be flagged as “late” because it is late during the factory production (a false negative), in the case, the service provider incurs real and sometimes substantial late penalties. Thus, there is a different risk for different false predictions. Thus, in some examples, the validation engine assigns a higher risk to potential false negative predictions.

The characteristics of the ratios of the number of “late” and “on time” orders being sampled (denoted as SL/SO) may be useful for analysis. For example, the relationships between the sampled ratios may be reversely proportional. In some examples, the interdependence of the ratios is explored, or the decision engine finds the optimal ratio that achieves the highest accuracy in the prediction. For example, if SL/SO=1, the resulting data set may contains similar amounts of late and on-time orders. The resulting data set used by the analysis module may be balanced in terms of the classification's labels.

The second analysis module (216) may include a nonlinear two-class binary decision tree mechanism that discovers underlying rules and regulations to separate the proposed job's details into the “on time” and “late” classifications. Here, the analysis module chooses the most useful attribute at each node of the tree to decide between the “on time” and “late” classifications. This analysis module may include program instructions that determine a threshold between a feasible classification and an infeasible classification.

The third analysis module (218) may include a probabilistic model based on Bayes' theorem. Given a new input vector xᵢ, the probabilistic model applies Bayes' theorem to compute the probabilities P(on time|xᵢ) and P(late|xᵢ) based on all the attribute values in xᵢ. It assigns each job request to the classification that has the higher probability. The current approach differs from the Bayesian approach with a parameter δ made to reflect the validation engine's bias to assign more job requests into the “on time” classification. This bias may exist due to the service provider striving to have enough resources to handle their service's demand. As a consequence, most of the proposed service contracts will be flagged as being “on time.” To handle this bias to a classification distribution imbalance, the analysis module uses program instructions. The program instructions may use the parameter δ is used to deliberately bias towards job requests falling into the “late” classifications by shifting the probability such that P′(on time|xᵢ)=P(on time|xᵢ)+δ and P′(late|xᵢ)=P(late|xᵢ)−δ. The value of δ is trained and updated gradually as more data points are added to the historical records. Initial testing shows that the parameter δ is quite effective for dealing with the biases that arise in the validation process.

Each of the analysis modules (214, 216, 218) produces a single feasibility prediction as to whether the proposed due date will be on time or not. Each of the predictions are fed into a conclusion module (220) to make a single conclusion as to whether the proposed due date is feasible. The conclusion engine (220) concludes as to whether the proposed due date is feasible based on the predictions from the analysis modules (214, 216, 218) and based on a conclusion policy. Both the conclusion engine (220) and the conclusion policy may be dynamic and reflect learning over time that makes the conclusions of feasibility more accurate over time. Such learning may occur through analysis of the historical records that are updated and have outdated historical records removed as appropriate to keep the feasibility determinations as up-to-date as possible.

The conclusion engine (220) considers the predications from the multiple analysis modules using a function that determines a threshold value for said feasibility. For example, each of the predictions from the analysis modules (214, 216, 218) may be assigned a different weight depending on the circumstances of the job request and/or condition of the production materials. These weights may also be determined on the basis of past success or failure in making accurate predictions. In some examples, the individual predictions are grouped together such that all the “on time” predictions are in a first group and all of the “late” predictions are in a second group. In this example, the group with the greater number of predictions is concluded to be the prediction. For example, if the group of “late” predications has the highest number of predictions, then the conclusion engine (220) will conclude that the proposed contract provision will be late. On the other hand, if the “on time” group contains more predictions, then the conclusion engine (220) will conclude that the contract provision is feasible. In yet other examples, if the “on time group” receives a single prediction, then the conclusion engine (220) concludes that the proposed job is feasible. Further, in yet other examples, the conclusion policy may cause the conclusion engine (220) to make the basis of its conclusion on other factors.

The conclusion policy may use different factors or weight factors differently depending on the type of service requested. For example, the ability to predict accurately an “on time” or “late” classification for service A may be best achieved with a first sub-policy. On the other hand, the ability to make an accurate prediction for service B may be best achieved through a second sub-policy. The conclusion policy and sub-policies may be dynamic and learned over time as service A and service B are evaluated from the historic data.

If the conclusion engine (220) concludes that the proposed due date is feasible, then the decision engine (204) causes the job request to be accepted. On the other hand, if the conclusion engine (220) concludes that the proposed due date is infeasible, then the decision engine (204) causes a recommendation to be made that potentially renders that proposed due date feasible, such as changing the priority of the job request. In other examples, the decision engine (204) may cause a recommendation to be made to postpone the proposed due date. Such recommendations may be sent back to the customer interface (208) for the customer to consider. In yet other examples, additional recommendations are made to assist the customer in finding a suitable accommodation. More than one recommendation may be made at a time. Thus, a customer may receive multiple alternative recommendations should his job request be flagged as being infeasible. Each recommendation implies a different response from the factory to fulfill the order obligation.

Initial testing of the principles described herein show that as more data points are added to the historical records that the feasibility determinations become more accurate over time. For example, as the historical records contain more data about jobs that were finished on time, jobs that were finished late, and their associated conditions of the production resources, the simulations were more accurate. As a consequence of more accurate simulations and more accurate predictive modeling, the outputs from the analysis modules and overall determination feasibilities also improved in accuracy.

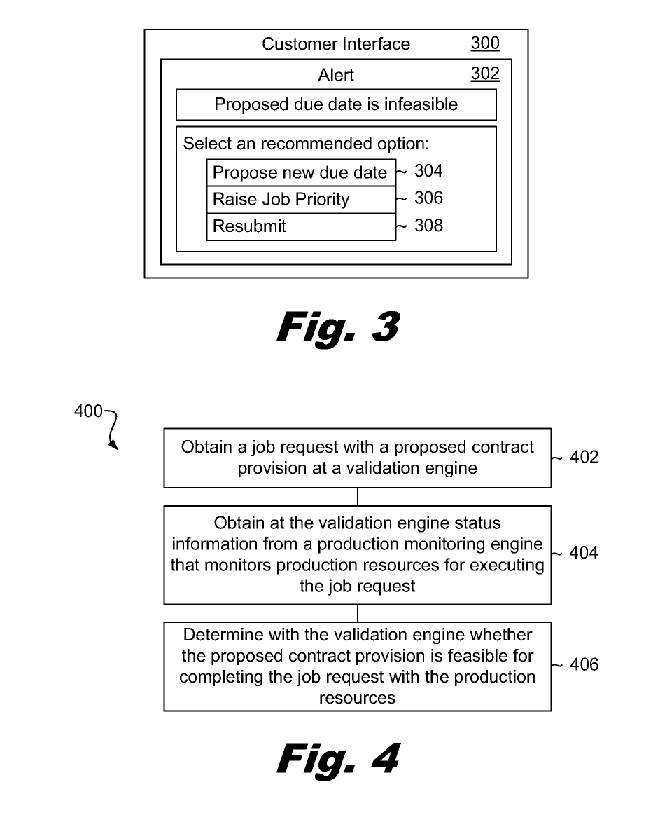

FIG. 3 is a diagram of an example of a customer interface (300) according to principles described herein. In this example, the customer interface displays an alert (302) that notifies a customer that the proposed due date of a submitted job request is infeasible. Additionally, the customer interface (300) also displays several recommended options (304, 306, 308) for the customer to consider that would make the proposed due date feasible.

A first recommended option (304) is to postpone the proposed due date or propose a new due date that is feasible. The recommended option may come with a recommended due date that is feasible. In other examples, the validation system solicits an acceptable due date from the customer and notifies the customer with a second alert if the new proposed due date suggested by customer is feasible or not.

A second recommended option (306) includes raising the priority of the job request so that the job request is placed ahead of existing job requests already in the queue. Rising priority may involve the customer paying more for the service than would have otherwise been charged had the proposed due date been feasible with the original priority. However, such an option indicates to the customer the reality that if the job request is to be done by the proposed due date, then the customer needs to compete for the production resources' high demand. Such an option may include indicating to the customer which level of priority is needed to complete the job request by the proposed due date. In other examples, the validation system allows the user to indicate at what level the customer is willing to pay to get the job request done by the proposed due date. If a newer priority is selected, then the validation system may send an additional alert if the newer priority is infeasible.

A third option (308) may include asking the customer to resubmit his or her job request. This option may be useful when the other options are not satisfactory to the customer. Since the simulation is run using real time factory conditions, by the time the validation system determines that a proposed due date is infeasible and the customer rejects the other options, the real time status of the production system may have changed such that the proposed due date is now feasible. For example, if the customer sends a proposed job request to the validation system through an email from the customer interface (300) and discovers the alert indicating infeasibility several hours later, the status of the production resources may have changed during those hours. For example, a job request may have been cancelled by another customer, an additional machine may have been added to the production resources, a broken production machine may have been fixed, or other status information relevant to the determination of whether the proposed due date is feasible may have changed. Thus, by resubmitting the job request with the same proposed due date at a later time, the validation system may find that the proposed due date is now feasible due to changed circumstances that occurred during the intervening time.

The customer may also resubmit the job with modifications. For example, the customer may resubmit the job with a reduced volume, reduced print quality (i.e. using a four color printer instead of a six color printer), simpler binding specifications, other modifications, or combinations thereof. These modifications can reduce the workload for the service provider and may cause the resubmitted job request to be feasible. Alternatively, the customer may combine multiple jobs into a single job for resubmission. Such an option allows the validation system to see a bigger picture, and as a result, consider how to optimize each of the different aspect of the resubmission, which potentially allows the validation engine to determine a way to order the different aspects of the job in a manner that makes the entire job feasible.

FIG. 4 is a diagram of an example of a method (400) for validating proposed contract provisions according to principles described herein. In this example, the method (400) includes obtaining (402) a job request with a proposed contract provision at a validation engine, obtaining (404) at the validation engine status information from a production monitoring engine that monitors production resources for completing the job request, and determining (406) with the validation engine whether the proposed contract provision is feasible for executing the job request with the production resources. In some examples, the proposed contract provision is a due date. In other examples, the proposed contract provision is a price for executing the job request. In yet other examples, other contract provisions are subject to validation according to the principles described herein.

In some examples, the job request is a printing job request, and the production resources are printing resources. The job request may include printing books, advertising material, magazines, posters, or other printed materials. The production resources include pre-press equipment, press equipment, post-press equipment, subsets thereof, or combinations thereof. The pre-pressing equipment may include equipment to design/develop the images to be printed, convert images to a digital format, perform other pre-press tasks, or combinations thereof. The post-press equipment may include equipment to apply finishes to the printed material, size the printed material, collate the printed material, sort the printed material, laminate the printed material, package the printed material, ship the printed material, perform other functions, or combinations thereof. In some examples, all of the processing tasks are completed with machines. However, in other examples, at least one of the processing tasks is performed manually.

The status information is provided through monitoring tools that are in communication with the production resources. The monitoring tools may include downloadable program instructions that gather status information about the production resources. In other examples, the monitoring tools include sensors that take measurements of the production resources productivity and use. The status information includes data about the production workload, resource utilization, resource performance, other information, or combinations thereof.

Determining whether the proposed contract provision is feasible includes simulating the proposed job with a simulation engine that runs a simulation of a current workload of the production resources based on the production resources' historical performance. The method may include inputting the job request and the proposed contract provision into multiple analysis modules that evaluate the feasibility based on different parameters and the simulation. If at least one of the analysis modules creates an output that indicates that the proposed contract provision is feasible, then the validation engine may conclude that the proposed contract provision is feasible. In other examples, the validation engine determines that the proposed contract provision is feasible or infeasible based on weighted factors, averages, other factors, or combinations thereof. In such an event where the proposed contract provision is determined to be feasible, the validation engine causes the job request to be accepted and a contract is formed.

If the proposed contract provision is determined to be infeasible, the validation engine causes a recommendation to be sent to the customer. In examples where the proposed contract provision is a due date, the recommendation may include postponing the due date, increasing the priority of the job request, making other changes, or combinations thereof. In examples where the proposed contract provision is pricing, the recommendation may include an alternative price, lowering the priority to match the proposed price, postponing the due date to match the proposed price, other considerations, of combinations thereof.

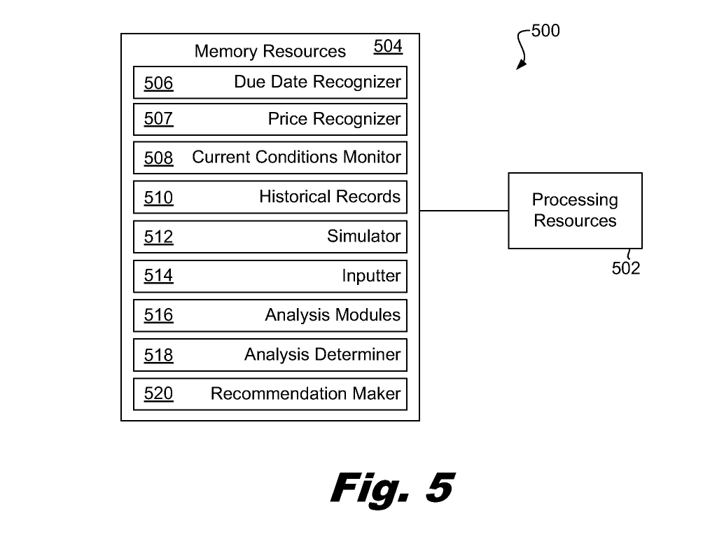

FIG. 5 is a diagram of an example of a validation system (500) according to principles described herein. In this example, the validation system (500) includes processing resources (502) that are in communication with memory resources (504). Processing resources (502) include at least one processor and other resources used to process programmed instructions. The memory resources (504) represent generally any memory capable of storing data such as programmed instructions or data structures used by the validation system (500). The programmed instructions shown stored in the memory resources (504) include a due date recognizer (506), a price recognizer (507), a current conditions monitor (508), a simulator (512), an inputter (514), analysis modules (516), an analysis determiner (518), and a recommendation maker (520). The data structures shown stored in the memory resources (504) include historical records (510).

The memory resources (504) include a computer readable storage medium that contains computer readable program code to cause tasks to be executed by the processing resources (502). The computer readable storage medium may be tangible and/or non-transitory storage medium. A non-exhaustive list of computer readable storage medium types includes non-volatile memory, volatile memory, random access memory, memristor based memory, write only memory, flash memory, electrically erasable program read only memory, or types of memory, or combinations thereof.

The due date recognizer (506) represents programmed instructions that, when executed, cause the processing resources (502) to recognize when a proposed due date associated with a job request is received. The price recognizer (507) represents programmed instructions that, when executed, cause the processing resources (502) to recognize a price to complete the job request. In some examples, the validation system (500) validates both the proposed price and the proposed due date. Alternatively, the validation system may validate a single contract provision. In other examples, the validation system (500) validates different contract proposals other than due dates and pricing.

A current conditions monitor (508) represents programmed instructions that, when executed, cause the processing resources (502) to request and/or receive real time information about the production resources. This real time information is combined with historical records (510) stored in the memory resources (504) to be run by the simulator (512). The simulator (512) represents programmed instructions that, when executed, cause the processing resources (502) to simulate the real time conditions of the production resources to determine under the real time conditions when the production resources can start the job request and how many resources can be devoted to the job request.

The inputter (514) represents programmed instructions that, when executed, cause the processing resources (502) to input details about the job request and the proposed due date into analysis modules (516). The analysis modules (516) represents programmed instructions that, when executed, cause the processing resources (502) to individually predict feasibility based on the simulation and the factory's historical records, and to approach those predictions differently. An analysis determiner (518) represents programmed instructions that, when executed, cause the processing resources (502) to determine based on the outputs of the analysis modules whether the proposed due date is feasible. The analysis determiner (518) may base its determination on a determination policy. Such a determination policy may give more weight to an output of a designated analysis module, consider all of the outputs collectively, determine that the proposed due date is feasible if at least one outcome determines that the proposed due date is feasible, determine that the proposed due date is infeasible if at least one of the outputs indicate that the proposed due date is infeasible, other considerations, or combinations thereof.

In the event that the proposed due date is determined to be infeasible, a recommendation to change the proposed due date, priority, size of the print job, or other detail about the job request may be made. The recommendation maker (520) represents programmed instructions that, when executed, cause the processing resources (502) to make such a recommendation to the customer through the customer interface.

Further, the memory resources (504) may be part of an installation package. In response to installing the installation package, the programmed instructions of the memory resources (504) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (502) and the memory resources (504) are located within the same physical component, such as a server, or a network component. The memory resources (504) may be part of the physical component's main memory, caches, registers, non-volatile memory, or elsewhere in the physical component's memory hierarchy. Alternatively, the memory resources (504) may be in communication with the processing resources (502) over a network. Further, the data structures, such as the libraries may be accessed from a remote location over a network connection while the programmed instructions are located locally. Thus, the validation system (500) may be implemented on a user device, on a server, on a collection of servers, or combinations thereof.

The validation system (500) of FIG. 5 may be part of a general purpose computer. However, in alternative examples, the validation system (500) is part of an application specific integrated circuit.

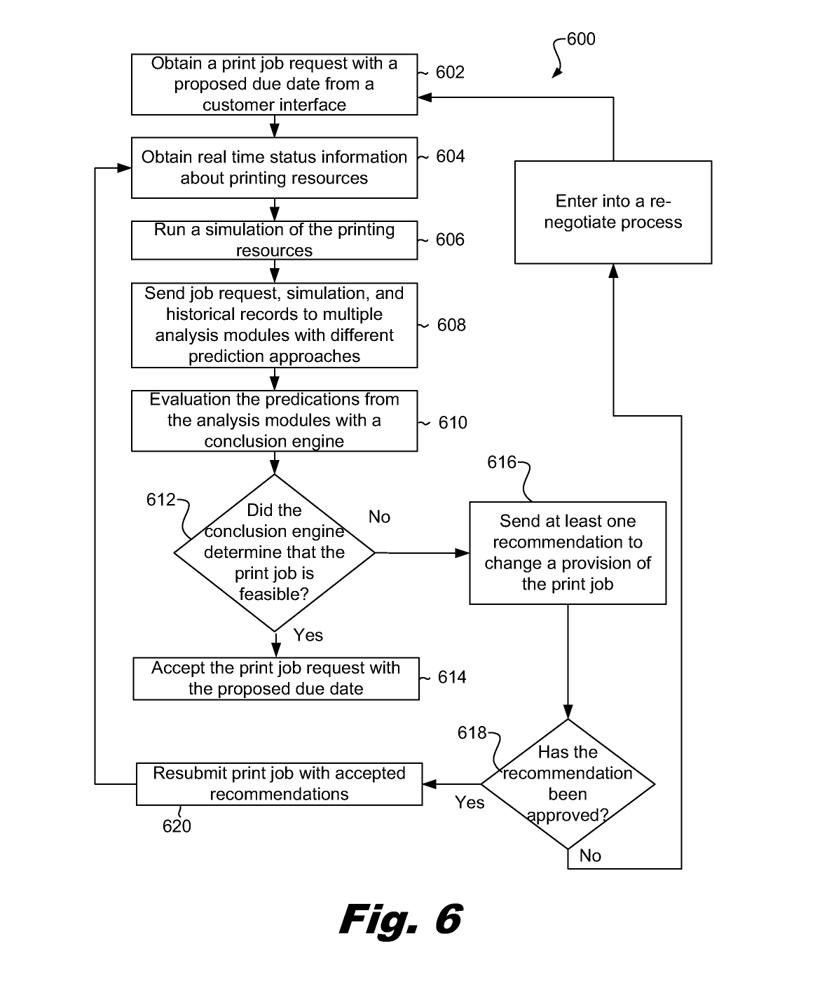

FIG. 6 is a diagram of an example of a flowchart (600) of a process for validating due dates according to principles described herein. In this examples, the process includes receiving (602) a print job request with a proposed due date from a customer interface, receiving (604) real time status information about printing resources, running (606) a simulation of the current state of the printing resources, and sending (608) the job request, the simulation and service provider historical records to multiple analysis modules with different prediction approaches.

The process also includes evaluating (610) the predictions from the analysis modules with a conclusion engine to make a single conclusion as to whether the print job is final. If the conclusion engine determines (612) that the print job is feasible then the process includes accepting (614) the print job request with the proposed due date. On the other hand, if the conclusion engine determines that the proposed due date is infeasible, then the process includes sending (616) at least one recommendation to change at least one of the attributes of the print job. If the recommendation is approved (618) then the print job with the recommended changes is resubmitted (620) through the validation engine. If the recommendation is not approved, then the proposed contract is entered (622) into a re-negotiation process. Next, the process includes obtaining (602) the print job request to go through the validation process again to account for any changes to the printing resources that occurred between the time that the print job was originally changed and the time that the recommendations were not approved.

While the examples above have been described with reference to specific analysis modules, the analysis modules may use any approach or mechanism to determine whether the proposed due dates are feasible. While the examples above are described with reference to specific numbers of analysis modules, any number of analysis modules may be used. Also, while the above examples are described with reference to specific factors for determining feasibility based on the outputs of the analysis modules, any factors in accordance with the principles described herein may be used to determine feasible based on the analysis module's outputs.

Further, while the examples above have been described with reference to specific mechanisms for monitoring the production resources, any mechanism for gathering status information about the production resources may be used. Further, while the simulation has been described above with reference to specific types of information, any information may be used to run the simulation in accordance with the principles described herein. While the examples above have been described with reference to specific recommendations, any recommendation to modify the job request in any manner that can potentially make the proposed contract provision feasible may be made.

The principles described herein may also be used to bring to the attention of the service provider's management those jobs that have a higher likelihood of violating a contract provision. For example, if a job request is accepted, but more than one of the analysis modules indicated that the job request would be infeasible, then the validation system may cause an email to be sent to management to notify them that a job has been accepted that has potential risks. In such an example, management may need to authorize the approval of the job request. In other examples, management may monitor the progress of the job request, and if deemed appropriate may outsource some of their work or increase their production resources' capacity to meet demand.

In some examples, the validation system takes remedial action and re-prioritizes job requests to ensure that jobs are finished on time. For example, the validation system may be aware based on the status information that it received from the production monitoring engine that many of the jobs already in queue have a low priority with due dates that are far off. In such circumstances, the validation system may automatically increase the priority of the requested job without increasing the charge to the customer to increase the revenue of the production resources.

Further, the principles described herein may be used to help determine the price to charge for the services. The service provider may charge more when its production resources are in high demand and charge less during slower periods. The validation system quantities the demand by looking at how difficult it is to meet the job's deadlines. The validation system may generate a series of alternative due dates, each associated with a different price, for the customer to consider.

The principles described herein may also be used to determine whether existing contracts are likely to miss their due dates while the simulation engine performs the simulation. In an event that such a circumstance is detected the validation engine may send notice to the service provider identifying a contract that is likely to miss its due date so the service provider can take remedial action. In other examples, the validation engine causes the contract that is at risk to be rushed to make the deadline.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for validating feasibility of proposed contract provisions, comprising:
obtaining a job request with a proposed contract provision at a validation engine;
obtaining at said validation engine status information from a production monitoring engine that monitors production resources for executing said job request; and
determining with said validation engine whether said proposed contract provision is feasible for executing said job request with said production resources.

2. The method of claim 1, wherein said status information includes data selected from a group of production workload, resource utilization, resource performance, resource status, and combinations thereof.

3. The method of claim 1, wherein determining with said validation engine whether said proposed contract provision is feasible includes running a simulation of a current workload with said requested job and expected future workloads with a simulation engine.

4. The method of claim 3, wherein determining with said validation engine whether said proposed contract provision is feasible includes inputting said job request and proposed contract provision into multiple analysis modules that evaluate feasibility based on different levels and/or domains of expertise.

5. The method of claim 4, wherein determining with said validation engine whether said proposed contract provision is feasible includes using a conclusion engine to consider predications from said multiple analysis modules and to form a single conclusion about said feasibility of said contract provision.

6. The method of claim 5, wherein using a conclusion engine to consider predications from said multiple analysis modules includes using a function to determine a threshold value for said feasibility.

7. The method of claim 4, wherein at least one of said multiple analysis modules comprises program instructions to create a domain specific classifications relating to a feasibility of said contract provision.

8. The method of claim 7, wherein said program instructions include a function that accounts for a bias to a classification distribution imbalance.

9. The method of claim 7, wherein said program instructions include a function that determines a threshold between a feasible classification and an infeasible classification.

10. The method of claim 1, further comprising accepting said job request in response to said validation engine determining that said proposed contract provision is feasible.

11. The method of claim 1, further comprising making a recommendation in response to said validation engine determining that said proposed contract provision is infeasible.

12. The method of claim 1, wherein said proposed contract provision is a proposed due date.

13. The method of claim 1, wherein said proposed contract provision is a price to execute said requested job.

14. A system for validating feasibility of proposed contract provisions, comprising:
a production monitoring engine to monitor printing resources for completing printing jobs and to send status information about said printing resources to a validation engine; and
said validation engine to obtain a job request and to determine whether a proposed due date of said job request is feasible for completing said job request with said production resources.

15. A computer program product validating feasibility of proposed contract provisions, comprising:
a tangible computer readable storage medium, said tangible computer readable storage medium comprising computer readable program code embodied therewith, said computer readable program code comprising program instructions that, when executed, causes a processor to:
obtain a print job request with a proposed due date;
obtain status information from a printing monitoring engine that monitors printing resources for completing said job request;
input said job request and proposed due date into multiple analysis modules to determine feasibility based on different parameters; and
determine that said due date is feasible if at least one of said analysis modules creates an output indicating that said due date is feasible.
